(19) United States
(12) Patent Application Publication
(10) Pub. No.: US 2004/0071410 A1
(43) Pub. Date: Apr. 15, 2004

(54) Illuminant USB cable

(76) Inventor: Ming-Chuan Ma, Hsintien City (TW)

Correspondence Address: RABIN & BERDO, P.C., Suite 500, 1101 14th STREET, N.W., Washington, DC, 20005, US

(21) Appl. No.: 10/673,463

(22) Filed: Sep. 30, 2003

Related U.S. Application Data
(63) Continuation-in-part of application No. 10/293,479, filed on Nov. 14, 2002.

(30) Foreign Application Priority Data
Aug. 29, 2002 (TW) 091213536

(51) Int. Cl. G02B 6/36

(52) U.S. Cl. 385/88

(57) ABSTRACT

An illuminant USB cable is constructed to include two USB connectors, each USB connector having a light permeable housing and a circuit board with a LED that emits light when the illuminant USB cable connected to a computer, a cable electrically connected between the circuit boards of the USB connectors, the cable having a light permeable tubular outer shell, and a fiber optic axially mounted within the tubular outer shell of the cable and connected between the light emitting elements of the USB connectors to receive light from the LEDs of the USB connectors and to refract light through the outer shell of the cable to the outside, the fiber optic having recessed portions for producing light spots when refracting light from the LED.

This application is a Continuation-In Part of my patent application Ser. No. 10/293,479, filed Nov. 14, 2002, and which claimed priority from Taiwanese Application No. 091213536, filed Aug. 29, 2002.

### BACKGROUND OF THE INVENTION

1. Field of the Invention

The present invention relates to an USB cable for connection between two electronic apparatus, for example, a computer and a computer peripheral apparatus and, more particularly to an illuminant USB cable, which produces light spots when electrically connected.

2. Description of the Related Art

Following fast development of computer technology, a variety of sophisticated computers and computer peripheral apparatus have been disclosed. When connecting multiple computer peripheral apparatus to a host computer, a hub may be used. Most commercially available hubs use USB (universal serial bus) connectors as interface means for the advantage of high electronic data signal transmission speed. The data signal transmission speed of a USB connector is much faster than a parallel port or serial bus port for personal computer. An USB cable can be used to connect a keyboard, computer mouse, computer joystick, scanner, digital camera, or any of a variety of computer peripheral apparatus to a computer. Because an USB cable is usually not well protected by cover means when connected to a computer, it tends to be touched or bent accidentally by people passing by, resulting in a connection failure. The user may be unable to find the connection failure soon when it happened. Frequently connect and disconnect the connection between the connector of an USB cable and a computer may cause the connector of the USB cable or the corresponding USB port of the computer to wear, resulting in interruption or instability of data transmission. Further, when an USB cable connected to a computer, it is normally arranged at the back side of the computer where is relatively dark. In case the USB cable is disconnected from the computer accidentally, the user may be unable to find the reason when the computer peripheral apparatus failed.

### SUMMARY OF THE INVENTION

The present invention has been accomplished under the circumstances in view. It is therefore the main object of the present invention to provide an illuminant USB cable, which gives light through the electrically insulative tubular outer shell when electrically connected, so that the user can know the working status of the illuminant USB cable subject to the presence of its illumination. To achieve this and other objects of the present invention, the illuminant USB cable comprises a cable, the cable having a light permeable tubular outer shell, two USB connectors at the ends of the cable, two light emitting elements, for example, LEDs respectively installed in the circuit boards of the USB connectors, and a fiber optic axially embedded in the cable and connected between the LEDs and adapted to receive light from the LEDs and to refract light to the outside of the light permeable outer shell of the cable. The housing of each USB connector may be made transparent so that light from the LED of the respective USB connector passes when the USB connector electrically connected. Further, the fiber optic has recessed portions irregularly arranged around the periphery that produce a lighting effect when refracting light.

### BRIEF DESCRIPTION OF THE DRAWINGS

FIG. 1 is an elevational view of an illuminant USB cable according to the present invention.

FIG. 2A is a perspective view in an enlarged scale of one end of the illuminant USB cable according to the present invention.

FIG. 2B is a perspective view in an enlarged scale of the other end of the illuminant USB cable according to the present invention.

FIG. 3 shows an application example of the illuminant USB cable according to the present invention.

FIG. 4 is an elevational view of an alternate form of the illuminant USB cable according to the present invention.

### DETAILED DESCRIPTION OF THE PREFERRED EMBODIMENT

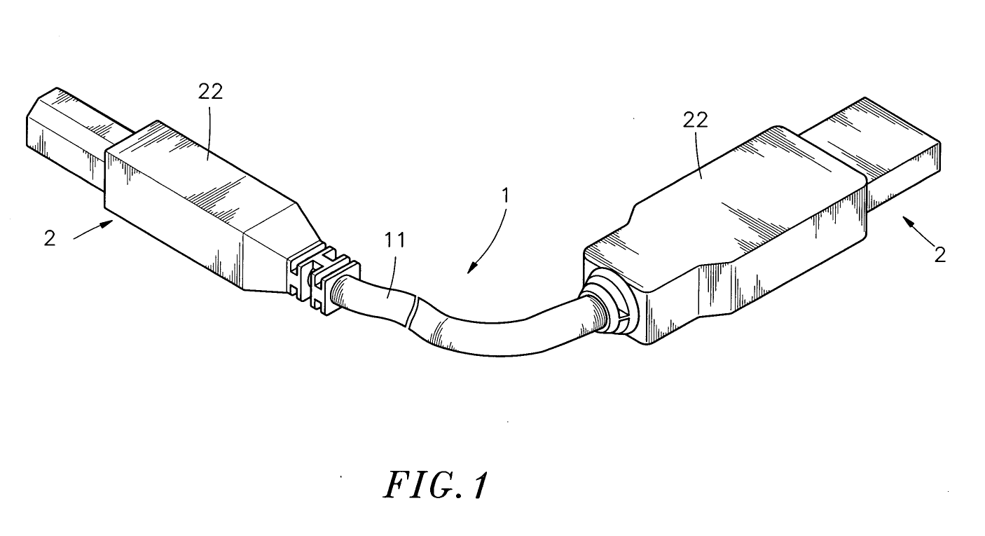

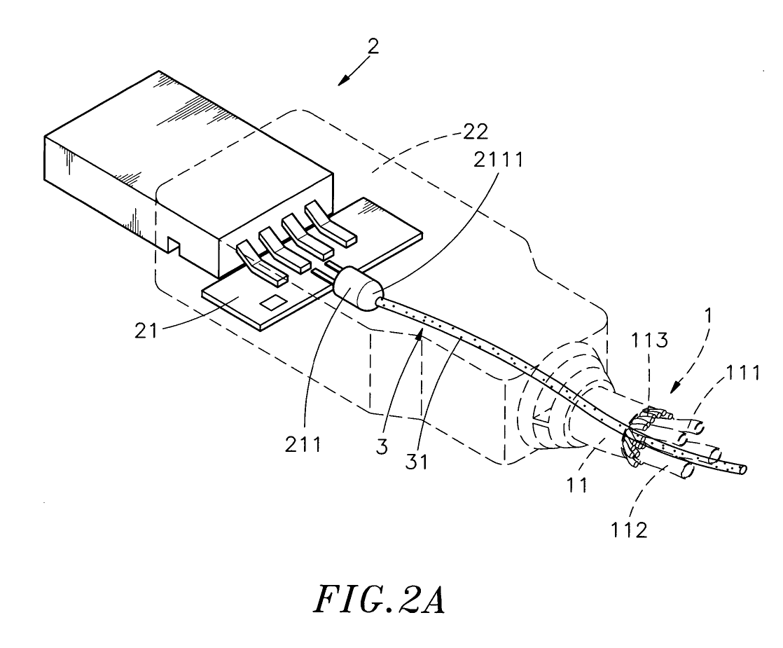

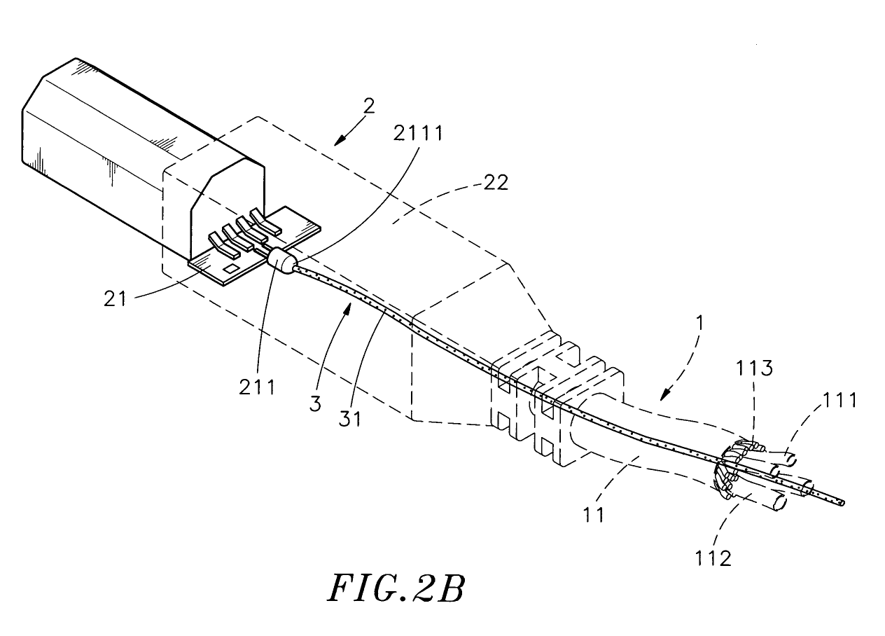

Referring to FIGS. 1, 2A, and 2B, an illuminant USB cable in accordance with the present invention is shown comprised of a cable 1, and two USB connectors 2 respectively provided at the ends of the cable 1. The cable 1 comprises signal lines 111, power lines 112, metal grounding wires 113, and an electrically insulative, transparent (or semitransparent), tubular outer shell 11 covering the signal lines 111, the power lines 112 and the metal grounding wires 113. Each USB connector 2 has a circuit board 21 fixedly provided inside the transparent (or semitransparent) housing 22 thereof. The housing 22 of each USB connector 2 admits light. The circuit board 21 comprises a light emitting element, for example, a LED (light emitting diode) 211. The signal lines 111, the power lines 112, and the metal grounding wires 113 are twisted into a twisted cord member before the formation of the tubular outer shell 11. The tubular outer shell 11 is directly molded on the twisted cord member of the signal lines 111, the power lines 112, and the metal grounding wires 113. The signal lines 111, the power lines 112, and the metal grounding wires 113 have the respective ends respectively connected to respective terminals of the circuit boards 21 of the connectors 2. Further, a fiber optic 3 is axially embedded in the cable 1 and connected between the light emitting side 2111 of the light emitting element 211 of the circuit board 21 of each USB connectors 2, the fiber optic 3 has irregularly arranged recessed portions 31 adapted to refract light.

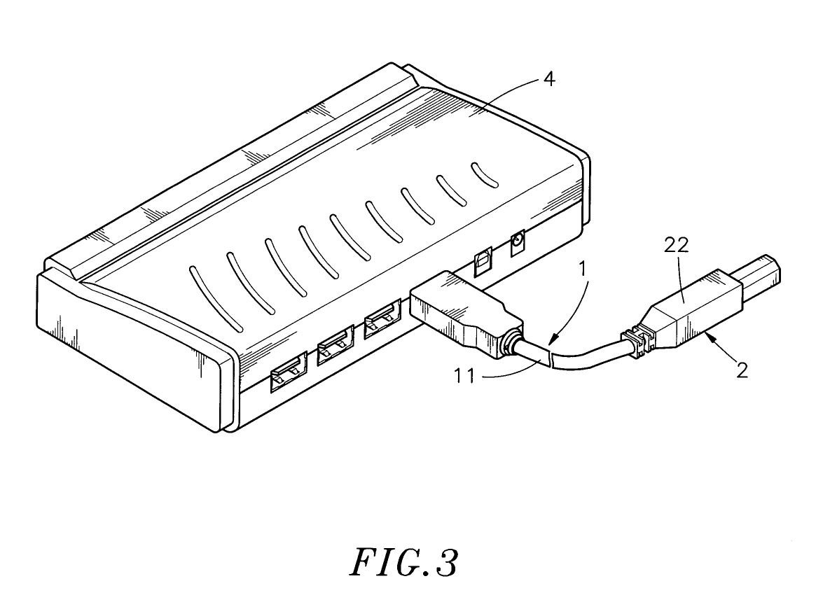

Referring to FIG. 3 and FIGS. 1, 2A and 2B again, the illuminant USB cable can be used to connect a computer peripheral apparatus (for example, a hub) 4 to a computer (not shown). When installed, the illuminant USB cable 1 receives power supply from the computer, and the light emitting elements 211 of the circuit boards 21 of the USB connectors 2 are turned on to emit light through the housings 22 of the USB connectors 2 to the outside, and at the same time the fiber optic 3 receives and refracts light from the light emitting elements 211 of the circuit boards 21 of the USB connectors 2, for enabling refracted light to pass through the tubular outer shell 11 of the cable 1. Due to light refracting effect, irregular light spots are formed on the fiber optic 3 at the recessed portions 31. When the illuminant USB cable disconnected from the computer by an external force accidentally, the light emitting elements 211 of the circuit boards 21 of the USB connectors 2 are off, and therefore the user immediately knows the disconnection status of the illuminant USB cable due to extinction of illumination. Therefore, the user can check the connection and data transmission status between the USB connectors 2 of the illuminant USB cable and the computer subject to the lighting status of the light emitting elements 211.

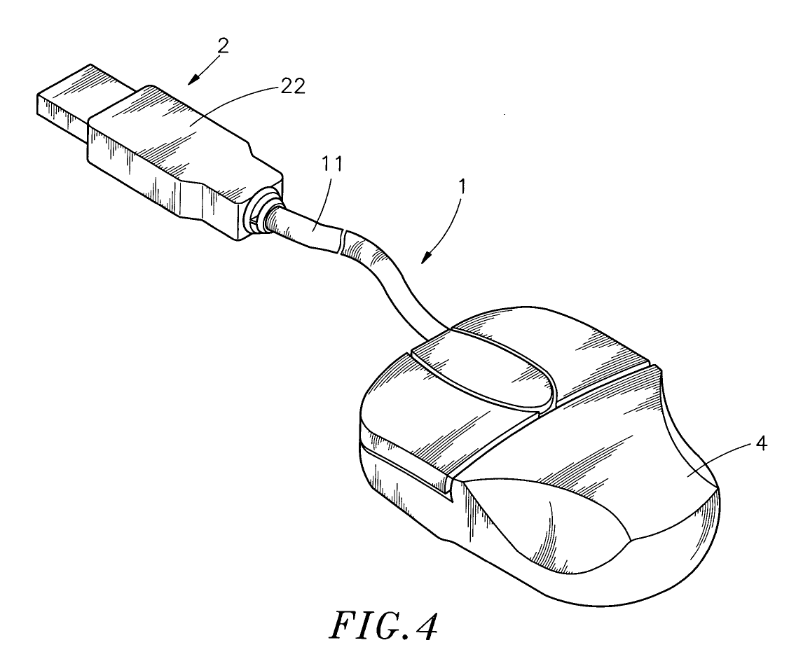

FIG. 4 shows an alternate form of the present invention. According to this embodiment, the illuminant USB cable comprises a cable 1, a USB connector 2 at one end of the cable 1, and a computer peripheral apparatus (for example, a mouse) 4 at the other end of the cable 1.

Because the illuminant USB cable produces light when electrically connected, it attracts consumers to buy. Further, the fiber optic 3 refracts light toward the outside of the USB cable through the electrically insulative, transparent (or semitransparent), tubular outer shell 11, the cable 1 produces a lighting effect during functioning of the illuminant USB cable.

A prototype of illuminant USB cable has been constructed with the features of the annexed drawings of FIGS. 1˜4. The illuminant USB cable functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An illuminant USB cable for connection between a computer and a peripheral apparatus, the illuminant USB cable comprising:
a cable, said cable comprising an electrically insulative tubular outer shell that admits light, signal lines, power lines, and grounding wires twisted with said signal lines and said power lines inside said tubular outer shell;
at least one USB connector each disposed at one end of said tubular outer shell, each said USB connector comprising a circuit board electrically connected to said cable, the circuit board of each said USB connector having a light emitting element installed therein; and
at least one fiber optic embedded in said cable and adapted to guide light from the light emitting element of said circuit board to the outside of said cable;
wherein said at least one fiber optic is respectively connected to a light emitting side of the light emitting element of the circuit board of each said USB connector, each having a plurality of recessed portions adapted to refract light from the light emitting element of each said USB connector.

2. The illuminant USB cable as claimed in claim 1, wherein said light emitting element is a light emitting diode.

3. The illuminant USB cable as claimed in claim 1, wherein said tubular outer shell of said cable is made of transparent material.

4. The illuminant USB cable as claimed in claim 1, wherein said tubular outer shell of said cable is made of semitransparent material.

5. The illuminant USB cable as claimed in claim 1, wherein said at least one USB connector each comprises a transparent housing.

6. The illuminant USB cable as claimed in claim 1, wherein said at least one USB connector each comprises a semitransparent housing.

7. The illuminant USB cable as claimed in claim 1, wherein the number of said at least one USB connector is 2, and the two USB connectors are respectively disposed at the ends of said cable.

8. The illuminant USB cable as claimed in claim 1, wherein the number of said at least one USB connector is 1; said cable has one end connected to the USB connector, and an opposite end connected to a computer peripheral apparatus.
